(19) United States
(12) Patent Application Publication
(10) Pub. No.: US 2025/0224055 A1
(43) Pub. Date: Jul. 10, 2025

(54) COUPLING DEVICE

(71) Applicant: NIDEC CORPORATION, Kyoto (JP)

(72) Inventors: Toshihiko TOKESHI, Kyoto (JP); Shinsuke HAMANO, Kyoto (JP); Tomoaki ANDO, Kyoto (JP); Taku MURAKAMI, Kyoto (JP); Hirotaka WATANABE, Kyoto (JP); Naoya NONOMURA, Kyoto (JP)

(21) Appl. No.: 19/092,196

(22) Filed: Mar. 27, 2025

Related U.S. Application Data
(63) Continuation of application No. PCT/JP2023/035514, filed on Sep. 28, 2023.

(30) Foreign Application Priority Data
Sep. 30, 2022 (JP) 2022-158518
Sep. 27, 2023 (JP) 2023-166376

(51) Int. Cl. F16L 27/08; F16L 29/04

(52) U.S. Cl. CPC F16L 27/0804; F16L 29/04

(57) ABSTRACT

A coupling device includes a first portion and a coupling portion. The first portion includes a first flow path and an attachment portion. The coupling portion includes a first tubular portion including one end portion to be connected to a second tubular portion of a second portion including a second flow path, and an arrangement portion provided at the other end portion of the first tubular portion and to be attached to the attachment portion. The movement of the arrangement portion with respect to the first portion is suppressed in the axial direction of the first tubular portion. The arrangement portion is movable with respect to the first portion in the radial direction of the first tubular portion. A maximum outer diameter of the arrangement portion is smaller than a maximum outer diameter of the first tubular portion.

### CROSS-REFERENCE TO RELATED APPLICATIONS

This application is a Continuation Application of PCT Application No. PCT/JP2023/035514, filed Sep. 28, 2023, and claims the benefit of priority to Japanese Patent Applications No. 2022-158518, filed on Sep. 30, 2022, and No. 2023-166376, filed on Sep. 27, 2023. The entire contents of which are hereby incorporated herein by reference.

### 1. FIELD OF THE INVENTION

The present disclosure relates to coupling devices.

### 2. BACKGROUND

A conventional fluid coupler includes a tubular member and a coupling mechanism (for example, CN 104500887 B). In the radial direction of the tubular member, the coupling mechanism is movable inside the tubular member.

In a coupling part such as a fluid coupler of CN 104500887 B, a space in which the arrangement portion such as a coupling mechanism moves is required inside a first tubular portion, so that the size of the coupling part in the radial direction increases.

### SUMMARY

The present disclosure has been made in view of the above problems, and describes coupling devices each capable of suppressing an increase in a radial size of a coupling portion even when an arrangement portion is movable with respect to a first portion.

An example embodiment of a coupling device of the present disclosure includes a first portion and a coupling portion. The first portion includes a first flow path and an attachment portion. The coupling portion includes a first tubular portion including one end portion to be connected to a second tubular portion of a second portion including a second flow path, and an arrangement portion provided at the other end portion of the first tubular portion and to be attached to the attachment portion. The movement of the arrangement portion with respect to the first portion is suppressed in the axial direction of the first tubular portion. The arrangement portion is movable with respect to the first portion in the radial direction of the first tubular portion. A maximum outer diameter of the arrangement portion is smaller than a maximum outer diameter of the first tubular portion.

According to the present disclosure, even when the arrangement portion is allowed to move with respect to the first portion, it is possible to suppress an increase in the radial size of the coupling portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an overall perspective view of a coupling system according to a first example embodiment of the present disclosure.

FIG. 2 is an overall perspective view of the coupling system of the first example embodiment.

FIG. 3 is a perspective view illustrating a cross section of the coupling device of the first example embodiment.

FIG. 4 is a cross-sectional view of the coupling device of the first example embodiment.

FIG. 5 is an overall perspective view of a coupling system according to a second example embodiment of the present disclosure.

FIG. 6 is a cross-sectional view of the coupling device of the second example embodiment.

FIG. 7 is a perspective view illustrating a cross section of the coupling device of the second example embodiment.

FIG. 8 is an overall perspective view of a coupling system according to a third example embodiment of the present disclosure.

### DETAILED DESCRIPTION

Hereinafter, example embodiments of the present disclosure will be described with reference to the drawings. The present description appropriately describes a first direction Z, a second direction X, and a third direction Y orthogonal to one another for easy understanding. Here, a direction from one end of a first tubular portion toward the other end of the first tubular portion is referred to as a “first direction Z”. The “first direction Z” is an example of a “predetermined direction”. A direction orthogonal to the first direction Z is referred to as a “second direction X”. A direction orthogonal to the first direction Z and the second direction X is referred to as a “third direction Y”.

In the present description, an “orthogonal direction” does not represent orthogonal in a strict sense, and includes, for example, a case of being orthogonal to a degree to which the effects of the present disclosure are achieved.

### First Example Embodiment

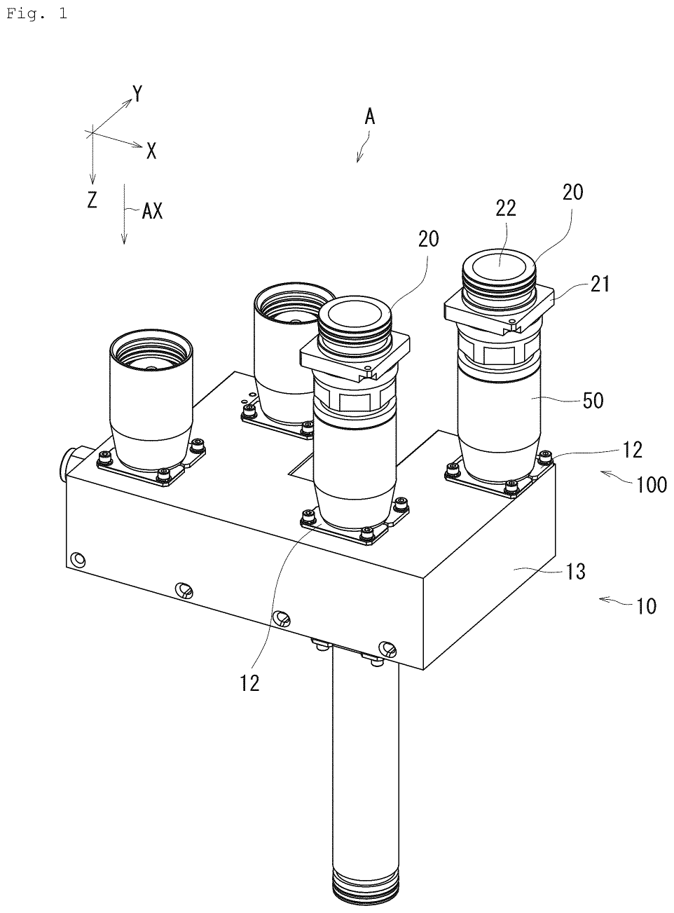

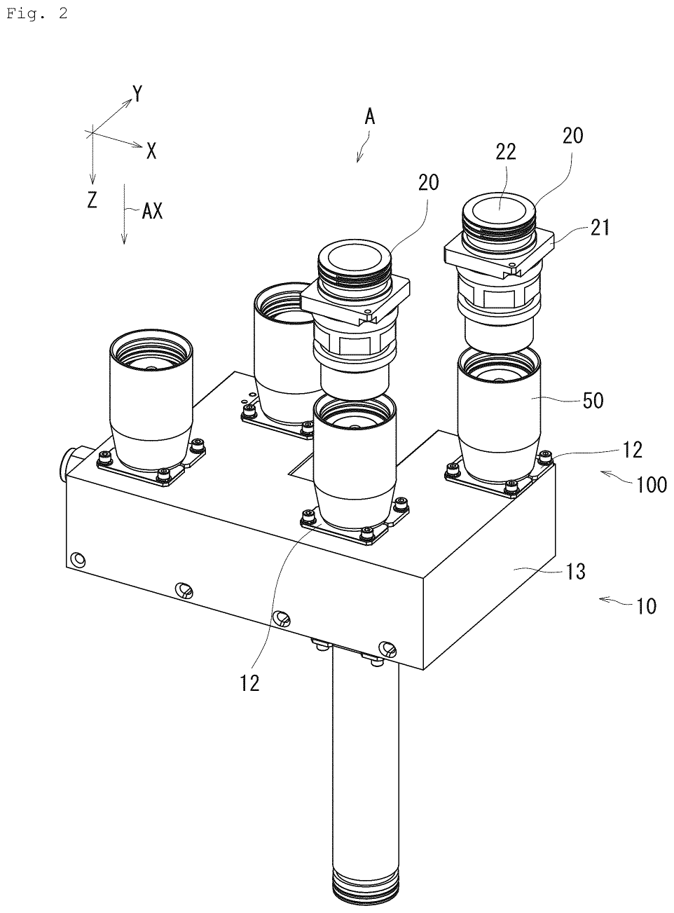

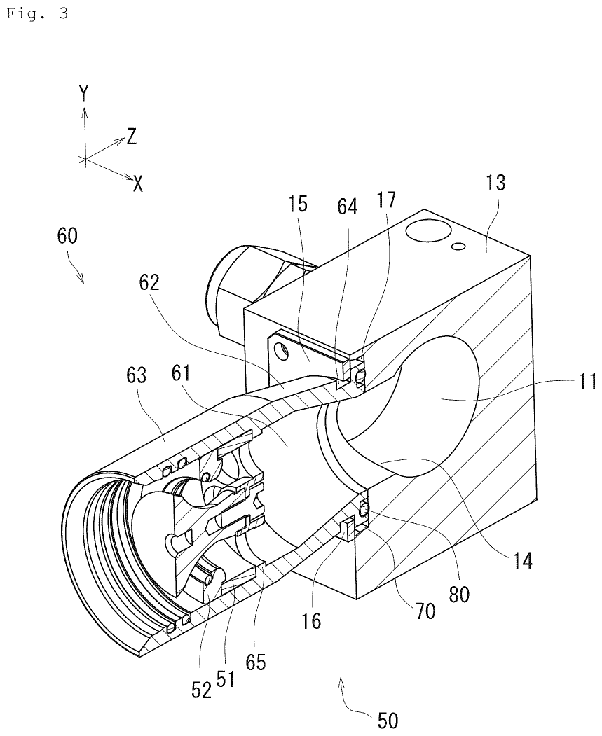

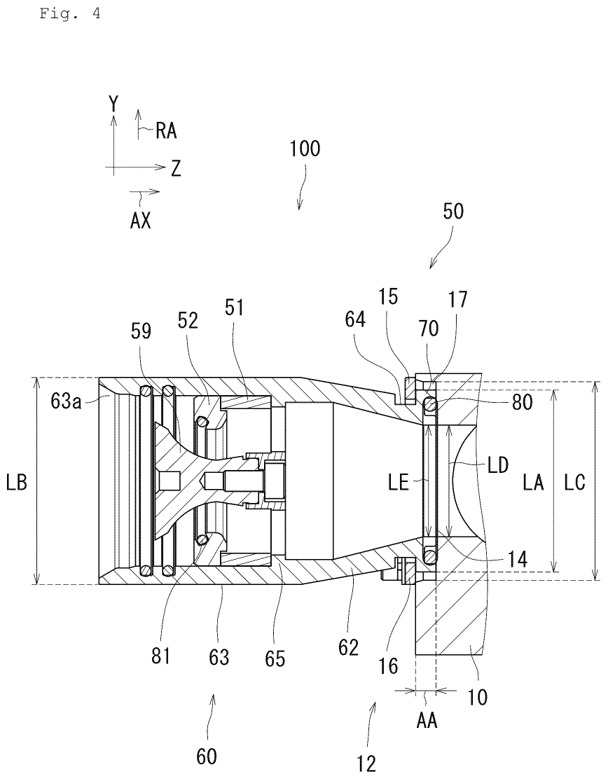

A coupling system A according to a first example embodiment of the present disclosure will be described. FIGS. 1 and 2 are overall perspective views of the coupling system A of the first example embodiment. FIG. 3 is a perspective view illustrating a cross section of a coupling device 100 of the first example embodiment. FIG. 4 is a cross-sectional view of the coupling device 100 of the first example embodiment. FIG. 1 is an overall perspective view of the coupling system A in a state where a first portion 10 and a second portion 20 are connected. FIG. 2 is an overall perspective view of the coupling system A in a state where the first portion 10 and the second portion 20 are separated.

As illustrated in FIGS. 1 to 4, the coupling system A includes the coupling device 100 and a plurality of second portions 20. In the first example embodiment, the coupling device 100 that can be connected to the four second portions 20 will be described, but the coupling device 100 may be connected to at least one second portion 20.

Each of the four second portions 20 includes a second tubular portion 21. The shape of the second tubular portion 21 is, for example, a cylindrical shape extending along the first direction Z. The second tubular portion 21 includes a second flow path 22. Specifically, the second flow path 22 is provided inside the second tubular portion 21. The second flow path 22 extends along the first direction Z. In FIGS. 1 and 2, only two second portions 20 are shown.

The coupling device 100 includes the first portion 10 and four coupling portions 50. The first portion 10 includes a first flow path 11, four attachment portions 12, and a first portion body 13.

The first portion body 13 includes four first openings 14. Each of the four first openings 14 communicates with the first flow path 11. Specifically, the shape of the first portion body 13 is, for example, a rectangular parallelepiped. The first flow path 11 is provided inside the first portion body 13. The four first openings 14 are provided to one surface of the first portion body 13 on the side opposite to the first direction Z. The four attachment portions 12 are located at the peripheral edges of the four first openings 14, respectively.

In the coupling system A according to the present example embodiment, when the first portion 10 and the four second portions 20 are connected to each other, the fluid flows from each of the four second flow paths 22 to the first flow path 11. As the fluid, for example, an antifreeze such as an ethylene glycol aqueous solution or a propylene glycol aqueous solution, pure water, or the like is used.

Next, the coupling portion 50 will be described in detail. The second portion 20 is connected to the coupling portion 50. Specifically, the coupling portion 50 includes a first tubular portion 60 and an arrangement portion 70.

The first tubular portion 60 includes a coupling flow path 61, an inclined portion 62, and a distal end portion 63. The coupling flow path 61 extends along the first direction Z. Specifically, the coupling flow path 61 is provided inside the distal end portion 63 and inside the inclined portion 62.

The first tubular portion 60 further includes one end portion and the other end portion. Specifically, the distal end portion 63 is provided to one end portion of the first tubular portion 60. The inclined portion 62 is provided to the other end portion of the first tubular portion 60. In other words, the distal end portion 63 is provided on the opposite side of the inclined portion 62 in the first direction Z.

One end portion of the first tubular portion 60 is connected to the second tubular portion 21 of the second portion 20. In other words, the distal end portion 63 is connected to the second tubular portion 21 of the second portion 20. An outer diameter LB of the distal end portion 63 is substantially the same along the first direction Z. Specifically, the shape of the distal end portion 63 is, for example, a cylindrical shape extending along the first direction Z.

The distal end portion 63 may include a tapered portion 63a in which the size of the inner diameter on the opposite side of the distal end portion 63 in the first direction Z decreases along the first direction Z. As a result, an inclination toward the center is formed by reducing the inner diameter, and the second tubular portion 21 can be easily inserted into the first tubular portion 60.

The inclined portion 62 is, for example, a truncated cone-shaped cylindrical body extending along the first direction Z. Specifically, the outer diameter of the first tubular portion 60 and the diameter of the coupling flow path 61 decrease along the first direction Z. As a result, since the flow path resistance of the coupling flow path 61 can be reduced, the fluid can smoothly flow along the first direction Z.

The arrangement portion 70 is provided to the other end portion of the first tubular portion 60. Specifically, the arrangement portion 70 is provided to the inclined portion 62. The arrangement portion 70 protrudes outward in a radial direction RA of the first tubular portion 60. The arrangement portion 70 is, for example, an annular plate-like body perpendicular to the first direction Z. The thickness of the plate-like body is, for example, a distance AA.

A maximum outer diameter LA of the arrangement portion 70 is smaller than a maximum outer diameter LB of the first tubular portion 60. As a result, it is possible to suppress an increase in the size of the coupling portion 50 in the radial direction RA.

Next, the attachment portion 12 will be described in detail. The arrangement portion 70 is attached to the attachment portion 12. The attachment portion 12 includes a first plate 15 and a second plate 16.

The first plate 15 is, for example, a plate-like body perpendicular to the first direction Z. The first plate 15 is attached to the first portion body 13. The first plate 15 is fixed to the first portion body 13 with a screw or the like. Specifically, the first plate 15 is attached to the first portion body 13 in a direction opposite to the first direction Z with a predetermined space. The predetermined space is, for example, the same distance as the thickness AA of the arrangement portion 70. Specifically, a first portion of the arrangement portion 70 is provided between the first portion body 13 and the first plate 15. In other words, the first portion of the arrangement portion 70 is sandwiched or supported by the first portion body 13 and the first plate 15.

The second plate 16 is, for example, a plate-like body perpendicular to the first direction Z. The second plate 16 is attached to the first portion body 13. The second plate 16 is fixed to the first portion body 13 with a screw or the like. Specifically, the second plate 16 is attached to the first portion body 13 in a direction opposite to the first direction Z of with a predetermined space. The predetermined space is, for example, the same distance as the thickness AA of the arrangement portion 70. Specifically, a second portion of the arrangement portion 70 is provided between the first portion body 13 and the second plate 16. In other words, the second portion of the arrangement portion 70 is sandwiched or supported by the first portion body 13 and the second plate 16.

The second portion of the arrangement portion 70 is a portion different from the first portion of the arrangement portion 70. As a result, the movement of the arrangement portion 70 with respect to the first portion 10 is suppressed in the axial direction AX of the first tubular portion 60. Specifically, the second portion of the arrangement portion 70 and the first portion of the arrangement portion 70 face each other with the first tubular portion 60 as the center. More specifically, the second portion of the arrangement portion 70 and the first portion of the arrangement portion 70 face each other in the third direction Y.

The first portion body 13 further includes four cavities 17. The four cavities 17 are provided to one surface of the first portion body 13 on the side opposite to the first direction Z. Specifically, the four cavities 17 are provided around the four first openings 14, respectively. The cavity 17 includes a space recessed by a predetermined distance in the first direction Z. The predetermined distance is, for example, the same distance as the thickness AA of the arrangement portion 70. The shape of the cavity 17 is, for example, a cylindrical shape extending along the first direction Z. A diameter LC of the cavity 17 is larger than the maximum outer diameter LA of the arrangement portion 70. As a result, the arrangement portion 70 is movable with respect to the first portion 10 in the radial direction RA of the first tubular portion 60. Specifically, the arrangement portion 70 is movable in the cavity 17 in the radial direction RA of the first tubular portion 60.

Here, a connecting method of connecting the coupling device 100 and the four second portions 20 will be described. When the coupling device 100 and the four second portions 20 are connected, the four second tubular portions 21 are inserted into the four first tubular portions 60. When the positions of the four first tubular portions 60 are deviated from the positions of the four second tubular portions 21, the positions of the four first tubular portions 60 move in the radial direction RA with respect to the first portion 10. Each of the four first tubular portions 60 independently moves with respect to the first portion 10. As a result, the four first tubular portions 60 and the four second tubular portions 21 can be appropriately connected. Therefore, connection failure can be suppressed, and fluid leakage can be suppressed.

As described above with reference to FIGS. 1 to 4, in the first example embodiment, even if the arrangement portion 70 can be moved with respect to the first portion 10, the maximum outer diameter LA of the arrangement portion 70 is smaller than the maximum outer diameter LB of the first tubular portion 60, so that it is possible to suppress an increase in the radial size of the coupling portion 50.

Here, a method of manufacturing the coupling device 100 will be described. The arrangement portion 70 of the coupling portion 50 is provided in the cavity 17. The first plate 15 is fixed to the first portion body 13 with a screw or the like. The second plate 16 is fixed to the first portion body 13 with a screw or the like. As a result, the coupling device 100 according to the present example embodiment can be easily manufactured only by fixing the first plate 15 and the second plate 16 to the first portion body 13.

Next, the coupling device 100 will be described in detail with reference to FIG. 4. As illustrated in FIG. 4, a first sealing portion 80 is located between the arrangement portion 70 and the attachment portion 12.

The first sealing portion 80 is located between the arrangement portion 70 and the attachment portion 12 in the axial direction AX. Specifically, the first sealing portion 80 is located in the first direction Z on the arrangement portion 70. The shape of the first sealing portion 80 is, for example, an annular shape. The material of the first sealing portion 80 is, for example, rubber. As a result, it is possible to suppress the fluid from leaking from between the arrangement portion 70 and the attachment portion 12.

More specifically, the diameter LD of the first opening 14 is equal to or larger than the diameter LE of the opening of the arrangement portion 70. As a result, when the first tubular portion 60 moves in the radial direction RA, a pressure loss due to the opening of the arrangement portion 70 facing the first portion body 13 can be suppressed. The arrangement portion 70 includes a groove 70a for disposing the first sealing portion 80. The distance from the inner end of the groove 70a to the inner end of the arrangement portion 70 is equal to or more than half of the difference between the diameter LC of the cavity 17 and the maximum outer diameter LA of the arrangement portion 70. As a result, even when the arrangement portion 70 moves in the attachment portion 12, it is possible to suppress exposure of the first sealing portion 80 to the first opening 14.

Furthermore, grease may be provided between the arrangement portion 70 and the attachment portion 12. Specifically, grease is applied to at least one of a surface of the arrangement portion 70 and a surface of the attachment portion 12. As a result, the arrangement portion 70 can easily move by sliding with respect to the first portion 10 in the radial direction RA of the first tubular portion 60. The grease is, for example, fluorine-based grease. As a result, in addition to making it difficult for the grease to flow in the fluid, the grease is less likely to dissolve in the fluid.

More specifically, the first tubular portion 60 further includes a recess 64. The recess 64 is recessed inward in the radial direction RA from the outer peripheral surface of the first tubular portion 60. The recess 64 has, for example, an annular shape when viewed from the first direction. The recess 64 is provided in a direction opposite to the first direction Z of the arrangement portion 70. The first plate 15 and the second plate 16 are located inside the recess 64. As a result, the movement of the arrangement portion 70 with respect to the first portion 10 is suppressed in the axial direction AX of the first tubular portion 60. In addition, even if the maximum outer diameter LA of the arrangement portion 70 is made smaller than the maximum outer diameter LB of the first tubular portion 60, the width in which the coupling portion 50 is movable with respect to the first portion 10 in the radial direction RA can be increased.

The first tubular portion 60 further includes a protruding portion 65. The protruding portion 65 protrudes inward in the radial direction RA from the inner peripheral surface of the first tubular portion 60. The protruding portion 65 is provided on the inner peripheral surface of the distal end portion 63. Specifically, the protruding portion 65 is provided on the first direction Z side of the distal end portion 63. The shape of the protruding portion 65 is, for example, an annular shape when viewed from the first direction Z.

The coupling portion 50 further includes an elastic portion 51, a valve portion 52, and a coupling mechanism 59. The coupling mechanism 59 is located at the center of the first tubular portion 60 along the first direction Z. The valve portion 52 is located on the opposite side of the elastic portion 51 in the first direction Z. The first direction Z side of the elastic portion 51 is fixed to the opposite side in the first direction Z of the protruding portion 65. When the first tubular portion 60 and the second tubular portion 21 are not connected to each other, the valve portion 52 pushed out in the direction opposite to the first direction Z by the elastic portion 51 comes into contact with the coupling mechanism 59 to suppress the fluid from leaking to the outside. Further, when the first tubular portion 60 and the second tubular portion 21 are connected, the second tubular portion 21 faces a surface of the valve portion 52 on the side opposite to the first direction Z, and is moved in the first direction Z, so that the fluid can flow between the coupling mechanism 59 and the valve portion 52. By providing the protruding portion 65 at the distal end portion 63, it is possible to suppress positional deviation and removal of the elastic portion 51 when the valve portion 52 moves.

The valve portion 52 is an annular body. A second sealing portion 81 is located inside the valve portion 52 in the radial direction RA. The shape of the second sealing portion 81 is, for example, an annular shape. The material of the second sealing portion 81 is, for example, rubber. As a result, when the first tubular portion 60 and the second tubular portion 21 are not connected, it is possible to suppress fluid leakage from between the coupling mechanism 59 and the valve portion 52.

The second sealing portion 81 is fixed to the valve portion 52 by an adhesive. As a result, it is possible to prevent the second sealing portion 81 from being detached from the valve portion 52 when an external force is applied to the second sealing portion 81. The adhesive is, for example, an epoxy-based adhesive, and can suppress generation of outgas. As a result, shrinkage of the adhesive after curing is suppressed, and detachment of the second sealing portion 81 from the valve portion 52 can be further suppressed.

### Second Example Embodiment

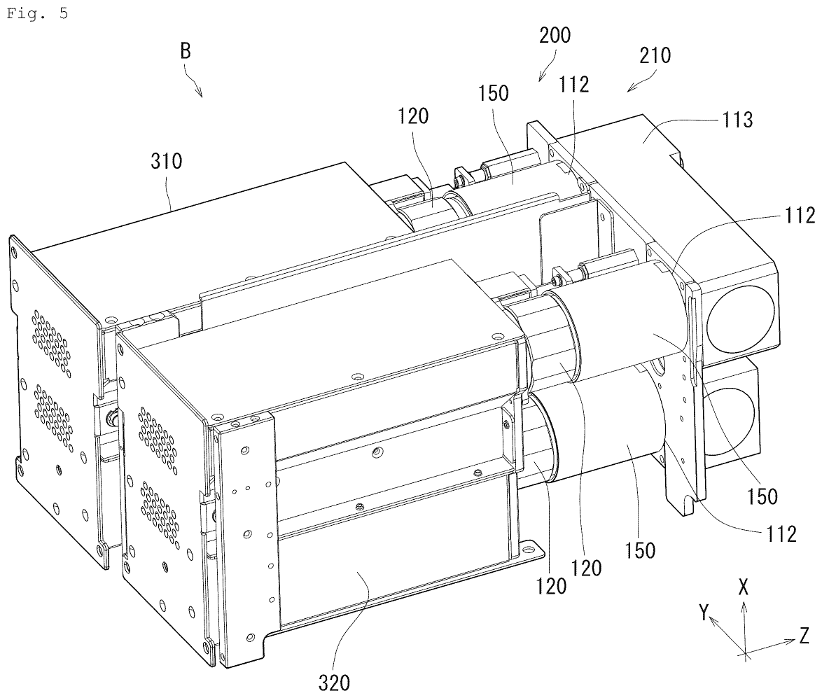

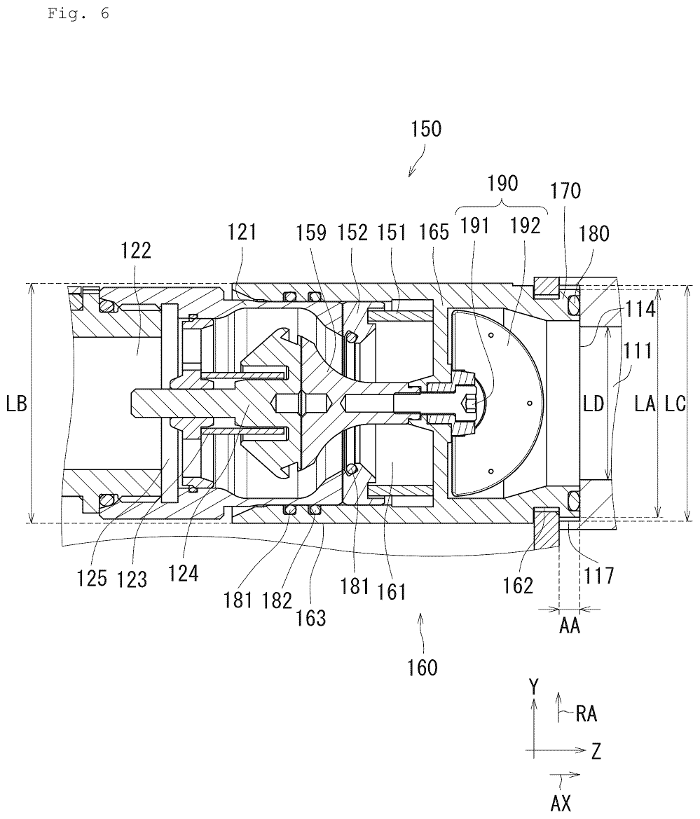

A coupling system B according to a second example embodiment of the present disclosure will be described. FIG. 5 is an overall perspective view of the coupling system B of the second example embodiment. FIG. 6 is a cross-sectional view of a coupling device 200 of the second example embodiment. FIGS. 5 and 6 are perspective views of the coupling system B in a state where a first portion 110 and a second portion 120 are connected.

As illustrated in FIGS. 5 and 6, the coupling system B includes the coupling device 200, a first pump device 310, and a second pump device 320.

Each of the first pump device 310 and the second pump device 320 includes two second portions 120. In other words, the coupling system B includes four second portions 120.

Each of the four second portions 120 includes a second tubular portion 121. The shape of the second tubular portion 121 is, for example, a polygonal tubular shape extending along the first direction Z. The second tubular portion 121 includes a second flow path 122. Specifically, the second flow path 122 is provided inside the second tubular portion 121. The second flow path 122 extends along the first direction Z.

The coupling device 100 includes the first portion 210 and four coupling portions 150. The first portion 210 includes a first flow path 111, four attachment portions 112, and a first portion body 113.

The first portion body 113 includes four first openings 114. Each of the four first openings 114 communicates with the first flow path 111. Specifically, the shape of the first portion body 113 is, for example, a rectangular parallelepiped. The first flow path 111 is provided inside the first portion body 113. The four first openings 114 are provided on one surface of the first portion body 113 on the side opposite to the first direction Z. The four attachment portions 112 are located at the peripheral edges of the four first openings 114, respectively.

In the coupling system B according to the second example embodiment, when the first portion 110 of the coupling device 200 and the two second portions 120 of the first pump device 310 are connected, the fluid flows from one second flow path 122 to the first flow path 111 and flows from the first flow path 111 to the other second flow path 122.

In addition, in the coupling system B according to the second example embodiment, when the first portion 110 of the coupling device 200 and the two second portions 120 of the second pump device 320 are connected, the fluid flows from one second flow path 122 to the first flow path 111 and flows from the first flow path 111 to the other second flow path 122.

Next, the coupling portion 150 will be described in detail. The second portion 20 is connected to the coupling portion 150. Specifically, the coupling portion 150 includes a first tubular portion 160 and an arrangement portion 170.

The first tubular portion 160 includes a coupling flow path 161, a distal end portion 163, and a stepped portion 162. The coupling flow path 161 extends along the first direction Z. Specifically, the coupling flow path 161 is provided inside the distal end portion 63 and inside the stepped portion 162.

The first tubular portion 160 further includes one end portion and the other end portion. Specifically, the distal end portion 163 is provided to one end portion of the first tubular portion 160. The stepped portion 162 is provided to the other end portion of the first tubular portion 160. In other words, the distal end portion 163 is provided on the opposite side of the stepped portion 162 in the first direction Z.

A sealing portion 181 and a sealing portion 182 are located inside the distal end portion 163 in the radial direction RA. In other words, the two sealing portions 181 and 182 are located inside the distal end portion 163 in the radial direction RA. The shape of each of the sealing portion 181 and the sealing portion 182 is, for example, an annular shape. The material of each of the sealing portion 181 and the sealing portion 182 is, for example, rubber. As a result, when the first tubular portion 160 and the second tubular portion 121 are connected, it is possible to suppress fluid leakage from between the inner peripheral surface of the first tubular portion 160 and the outer peripheral surface of the second tubular portion 121.

The stepped portion 162 is, for example, a cylindrical body extending along the first direction Z. Specifically, the outer diameter of the stepped portion 162 is smaller than the outer diameter of the distal end portion 163.

One end portion of the first tubular portion 160 is connected to the second tubular portion 121 of the second portion 120. In other words, the distal end portion 163 is connected to the second tubular portion 121 of the second portion 120. An outer diameter LB of the distal end portion 163 is substantially the same along the first direction Z. Specifically, the shape of the distal end portion 163 is, for example, a cylindrical shape extending along the first direction Z.

The arrangement portion 170 is provided to the other end portion of the first tubular portion 160. The arrangement portion 170 protrudes outward in the radial direction RA of the first tubular portion 160. The arrangement portion 170 is, for example, an annular plate-like body perpendicular to the first direction Z. The thickness of the plate-like body is, for example, a distance AA.

A maximum outer diameter LA of the arrangement portion 170 is smaller than a maximum outer diameter LB of the first tubular portion 160. As a result, it is possible to suppress an increase in the size of the coupling portion 50 in the radial direction RA.

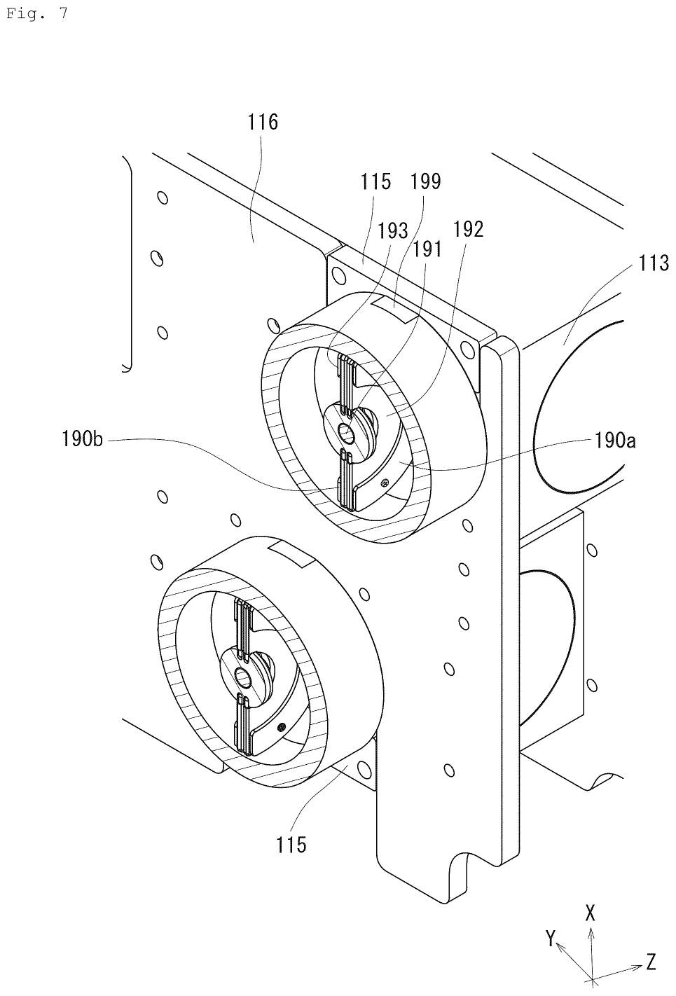

Next, the attachment portion 112 will be described in detail with reference to FIG. 7. FIG. 7 is a perspective view illustrating a cross section of a coupling device of the second example embodiment. As illustrated in FIG. 7, the arrangement portion 170 is attached to the attachment portion 112. The attachment portion 112 includes a plurality of first plates 115 and a second plate 116.

The first plate 115 is, for example, a plate-like body perpendicular to the first direction Z. The first plate 115 is attached to the first portion body 113. The first plate 115 is fixed to the first portion body 113 with a screw or the like. Specifically, the first plate 115 is attached to the first portion body 113 in a direction opposite to the first direction Z with a predetermined space. The predetermined space is, for example, the same distance as the thickness AA of the arrangement portion 170. Specifically, a first portion of the arrangement portion 170 is provided between the first portion body 113 and the first plate 115. In other words, the first portion of the arrangement portion 170 is sandwiched or supported by the first portion body 113 and the first plate 115.

The second plate 116 is, for example, a plate-like body perpendicular to the first direction Z. The size of the second plate 116 is larger than the size of the first plate 115. The second plate 116 corresponds to the four arrangement portions 170. The second plate 116 is attached to the first portion body 113. The second plate 116 is fixed to the first portion body 113 with a screw or the like. Specifically, the second plate 116 is attached to the first portion body 113 in a direction opposite to the first direction Z of with a predetermined space. The predetermined space is, for example, the same distance as the thickness AA of the arrangement portion 170. Specifically, second portions of the four arrangement portions 170 are provided between the first portion body 113 and the second plate 116. In other words, the second portions of the four arrangement portions 170 are sandwiched or supported by the first portion body 113 and the second plate 116.

Specifically, the second plate 116 overlaps both one first portion 110 and another first portion 110 in both the second direction X and the third direction Y. Each of the four first plates 115 covers half of the outer periphery of the one first portion 110, and the second plate 116 covers half of the outer periphery of the four first portions 110. The first plate 115 and the second plate 116 face each other at straight portions in the third direction Y. For example, the lower end of the first plate 115 and the upper end of the second plate 116 face each other, or the upper end of the first plate 115 and the lower end of the second plate 116 face each other. Since the first plate 115 is inserted along the third direction Y, the arrangement is easy and the positional deviation can be reduced.

The second portion of the arrangement portion 170 is a portion different from the first portion of the arrangement portion 170. As a result, movement of the arrangement portion 170 with respect to the first portion 110 is suppressed in the axial direction AX of the first tubular portion 160. Specifically, the second portion of the arrangement portion 170 and the first portion of the arrangement portion 170 face each other with the first tubular portion 160 as the center. More specifically, the second portion of the arrangement portion 170 and the first portion of the arrangement portion 170 face each other in the third direction Y.

The first portion body 113 further includes four cavities 117. The four cavities 117 are provided on one surface of the first portion body 113 on the side opposite to the first direction Z. Specifically, the four cavities 117 are provided around the four first openings 114, respectively. The cavity 117 includes a space recessed by a predetermined distance in the first direction Z. The predetermined distance is, for example, the same distance as the thickness AA of the arrangement portion 170. The shape of the cavity 117 is, for example, a cylindrical shape extending along the first direction Z. A diameter LC of the cavity 117 is larger than the maximum outer diameter LA of the arrangement portion 170. As a result, the arrangement portion 170 is movable with respect to the first portion 110 in the radial direction RA of the first tubular portion 160. Specifically, the arrangement portion 170 is movable in the cavity 117 in the radial direction RA of the first tubular portion 160.

Here, a connecting method of connecting the coupling device 200 and the four second portions 120 will be described. When the coupling device 200 and the first pump device 310 are connected, the two second tubular portions 121 are inserted into the two first tubular portions 160. When the positions of the two first tubular portions 160 are displaced from the positions of the two second tubular portions 121, the positions of the two first tubular portions 160 move in the radial direction RA with respect to the first portion 110. Each of the two first tubular portions 160 independently moves with respect to the first portion 110. As a result, the two first tubular portions 160 and the two second tubular portions 121 can be appropriately connected. Therefore, connection failure can be suppressed, and fluid leakage can be suppressed.

When the coupling device 200 and the second pump device 320 are connected, the two second tubular portions 121 are inserted into the two first tubular portions 160. When the positions of the two first tubular portions 160 are displaced from the positions of the two second tubular portions 121, the positions of the two first tubular portions 160 move in the radial direction RA with respect to the first portion 110. Each of the two first tubular portions 160 independently moves with respect to the first portion 110. As a result, the two first tubular portions 160 and the two second tubular portions 121 can be appropriately connected. Therefore, connection failure can be suppressed, and fluid leakage can be suppressed.

As described above with reference to FIGS. 5 to 7, in the second example embodiment, even if the arrangement portion 170 is allowed to move with respect to the first portion 110, the maximum outer diameter LA of the arrangement portion 170 is smaller than the maximum outer diameter LB of the first tubular portion 160, so that it is possible to suppress an increase in the radial size of the coupling portion 150.

Here, a method of manufacturing the coupling device 200 will be described. The second plate 116 is fixed to the first portion body 113 with a screw or the like. The arrangement portion 170 of the coupling portion 150 is provided in the cavity 117. The first plate 115 is fixed to the first portion body 113 with a screw or the like. As a result, the coupling device 200 according to the present second example embodiment can be easily manufactured only by fixing the first plate 115 and the second plate 116 to the first portion body 113.

Next, the coupling device 200 will be described in detail with reference to FIG. 6. As illustrated in FIG. 6, the first sealing portion 180 is located between the arrangement portion 170 and the attachment portion 112.

The first sealing portion 180 is located between the arrangement portion 170 and the attachment portion 112 in the axial direction AX. Specifically, the first sealing portion 180 is located in the first direction Z of the arrangement portion 170. The shape of the first sealing portion 180 is, for example, an annular shape. The material of the first sealing portion 180 is, for example, rubber. As a result, it is possible to suppress the fluid from leaking from between the arrangement portion 170 and the attachment portion 112.

More specifically, the diameter LD of the first opening 114 is equal to or larger than the diameter LE of the opening of the arrangement portion 170. As a result, when the first tubular portion 160 moves in the radial direction RA, a pressure loss due to the opening of the arrangement portion 170 facing the first portion body 113 can be suppressed.

The first tubular portion 160 further includes a protruding portion 165. The protruding portion 165 protrudes inward in the radial direction RA from the inner peripheral surface of the first tubular portion 160. The protruding portion 165 is provided to the inner peripheral surface of the distal end portion 163. Specifically, the protruding portion 165 is provided on the first direction Z side of the distal end portion 163. The shape of the protruding portion 165 is, for example, an annular shape when viewed from the first direction Z.

The second tubular portion 121 further includes an elastic portion 123, a coupling mechanism 124, and a protruding portion 125 in addition to the second flow path 122. The protruding portion 125 protrudes inward in the radial direction RA from the inner peripheral surface of the second tubular portion 121. The first direction Z side of the elastic portion 151 is fixed to the first direction Z side of the protruding portion 125. The coupling mechanism 124 is located at the center of the second tubular portion 121 along the first direction Z. The coupling mechanism 124 is located on the first direction Z side of the elastic portion 123.

When the first tubular portion 160 and the second tubular portion 121 are not connected, the coupling mechanism 124 pushed out toward the first direction Z side by the elastic portion 123 comes into contact with the distal end portion of the second tubular portion 121, thereby suppressing fluid leakage to the outside. When the first tubular portion 160 and the second tubular portion 121 are connected, the first tubular portion 160 faces the surface of the coupling mechanism 124 on the side opposite to the first direction Z, and is moved in the direction opposite to the first direction Z, so that the fluid can flow between the coupling mechanism 124 and the distal end portion of the second tubular portion 121.

The coupling portion 150 further includes the elastic portion 151, a valve portion 152, a coupling mechanism 159, and a check valve 190. The coupling mechanism 159 is located at the center of the first tubular portion 160 along the first direction Z. The valve portion 152 is located on the opposite side of the elastic portion 151 in the first direction Z. The first direction Z side of the elastic portion 151 is fixed to the opposite side in the first direction Z of the protruding portion 165. When the first tubular portion 160 and the second tubular portion 121 are not connected to each other, the valve portion 152 pushed out in the direction opposite to the first direction Z by the elastic portion 151 comes into contact with the coupling mechanism 159 to suppress the fluid from leaking to the outside. Further, when the first tubular portion 160 and the second tubular portion 121 are connected, the second tubular portion 121 faces a surface of the valve portion 152 on the side opposite to the first direction Z, and is moved in the first direction Z, so that the fluid can flow between the coupling mechanism 159 and the valve portion 152.

The valve portion 152 is an annular body. The second sealing portion 181 is located inside the valve portion 152 in the radial direction RA. The shape of the second sealing portion 181 is, for example, an annular shape. The material of the second sealing portion 181 is, for example, rubber. As a result, when the first tubular portion 160 and the second tubular portion 121 are not connected, it is possible to suppress fluid leakage from between the coupling mechanism 159 and the valve portion 152.

The second sealing portion 181 is fixed to the valve portion 152 by an adhesive. As a result, it is possible to prevent the second sealing portion 181 from being detached from the valve portion 152.

The check valve 190 is located on the first direction Z side of the coupling mechanism 159. According to the check valve 190, the fluid can flow from the second flow path 122 to the coupling flow path 161 and cannot flow from the coupling flow path 161 to the second flow path 122.

Specifically, the check valve 190 includes a hinge 191, a first semicircular plate 192, and a second semicircular plate 193. The hinge 191 is located on the first direction Z side of the coupling mechanism 159. Each of the first semicircular plate 192 and the second semicircular plate 193 is rotatable by the hinge 191 on a rotation axis along the second direction X. Each of the first semicircular plate 192 and the second semicircular plate 193 opens the coupling flow path 161 in a state of being inclined with respect to the first direction Z. On the other hand, each of the first semicircular plate 192 and the second semicircular plate 193 closes the coupling flow path 161 in a state of being orthogonal to the first direction Z. Although the coupling portion 150 in which the fluid flows from the second flow path 122 to the coupling flow path 161 will be described in the second example embodiment, the check valve 190 may be located in the coupling portion 150 in which the fluid flows from the coupling flow path 161 to the second flow path 122. The check valve 190 may further include a first cushion material 190a and a second cushion material 190b. The first cushion material 190a is located on a surface of the first semicircular plate 192 opposite to the first direction Z. The second cushion material 190b is located on a surface of the second semicircular plate 193 opposite to the first direction Z. As a result, each of the first semicircular plate 192 and the second semicircular plate 193 comes into contact with the protruding portion 165 when closing the coupling flow path 161, but an impact on the protruding portion 165 can be suppressed.

The first tubular portion 160 further includes a notch 199. The notch 199 is provided to the outer peripheral surface of the first tubular portion 60 on the second direction X side. Specifically, the notch 199 is provided to the rotation shaft of the check valve 190. As a result, by disposing the notch 199 in the second direction X, it is possible to prevent the first semicircular plate 192 and the second semicircular plate 193 from rotating due to the gravity. The notch 199 may be provided to the outer peripheral surface of the first tubular portion 60 on the side opposite to the second direction X.

### Third Example Embodiment

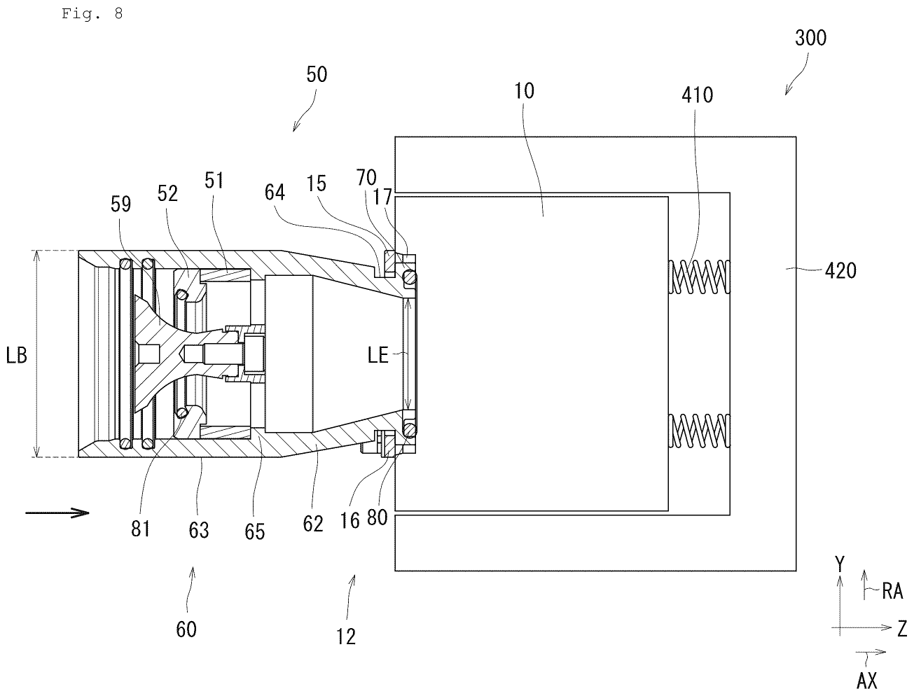

A coupling system C according to a third example embodiment of the present disclosure will be described. FIG. 8 is a cross-sectional view of the coupling system C of the third example embodiment. As illustrated in FIG. 8, the coupling system C includes a coupling device 300.

The coupling device 300 includes a first portion 10, a coupling portion 50, an elastic portion 410, and a main body 420. The main body 420 surrounds the first portion 10.

The material of the elastic portion 410 is, for example, a spring or rubber. The elastic portion 410 is located between the first portion 10 and the main body 420. Specifically, the elastic portion 410 is located between a surface of the first portion 10 on the side of the one direction Z and a surface of the main body 420 on the side opposite to the one direction Z. As a result, the first portion 10 is movable with respect to the main body 420 in the axial direction AX of the first tubular portion 60.

As described above with reference to FIG. 8, in the third example embodiment, the second tubular portion 21 is inserted into the first tubular portion 60 when the coupling device 300 and the second portion 20 are coupled. When the position of the first tubular portion 60 is deviated from the position of the second tubular portion 21, the position of the first tubular portion 60 moves in the radial direction RA with respect to the first portion 10, and the position of the first tubular portion 60 moves in the axial direction AX with respect to the main body 420. As a result, the first tubular portion 60 and the second tubular portion 21 can be appropriately connected. Therefore, connection failure can be suppressed, and fluid leakage can be suppressed.

The example embodiments of the present disclosure have been described above with reference to the drawings. However, the above example embodiments are merely examples of the present disclosure, and the present disclosure is not limited to the above example embodiments, and can be implemented in various aspects without departing from the gist of the present disclosure. The drawings schematically show respective constituent elements mainly for easy understanding, and the thickness, length, number, and the like of the respective constituent elements that are shown may be different from the actual ones for convenience of the drawings. The material, shape, dimensions, and the like of the respective constituent elements described in the above example embodiments are merely examples and are not particularly limited, and various modifications can be made without substantially departing from the effects of the present disclosure. The configuration of the example embodiment may be appropriately modified without departing from the technical idea of the present disclosure. The example embodiments may also be implemented in combination as far as possible.

Example embodiments of the present invention may also have any of the following configurations.

(1) A coupling device including a first portion including a first flow path and an attachment portion, and a coupling portion, wherein the coupling portion includes a first tubular portion including one end portion to be connected to a second tubular portion of a second portion including a second flow path, and an arrangement portion provided to another end portion of the first tubular portion and to be attached to the attachment portion, movement of the arrangement portion with respect to the first portion is suppressed in an axial direction of the first tubular portion, the arrangement portion is movable with respect to the first portion in a radial direction of the first tubular portion, and a maximum outer diameter of the arrangement portion is smaller than a maximum outer diameter of the first tubular portion.

(2) The coupling device according to (1), wherein the arrangement portion protrudes outward in the radial direction of the first tubular portion, and a first sealing portion is located between the arrangement portion and the attachment portion.

(3) The coupling device according to (1) or (2), wherein the attachment portion includes a first plate attached to a first portion body including a first opening communicating with the first flow path, and a second plate attached to the first portion body, a first portion of the arrangement portion is provided between the first portion body and the first plate, a second portion of the arrangement portion is provided between the first portion body and the second plate, and the second portion is a portion different from the first portion.

(4) The coupling device according to (3), wherein a diameter of the first opening is equal to or larger than a diameter of an opening of the arrangement portion.

(5) The coupling device according to any one of (1) to (4), wherein the first tubular portion includes a coupling flow path extending along a predetermined direction, and an inclined portion in which an outer diameter of the first tubular portion and a diameter of the coupling flow path decrease along the predetermined direction, and the predetermined direction indicates a direction from the one end portion of the first tubular portion toward the another end portion of the first tubular portion.

(6) The coupling device according to (5), wherein the first tubular portion includes a recess recessed radially inward from an outer peripheral surface of the first tubular portion, and the recess is provided to the arrangement portion in a direction opposite to the predetermined direction.

(7) The coupling device according to any one of (1) to (6), wherein the first tubular portion further includes a distal end portion provided to a side opposite to the predetermined direction with respect to the inclined portion, and a protruding portion protruding radially inward from an inner peripheral surface of the first tubular portion, the coupling portion further includes: an elastic portion, and a valve portion located on a side opposite to the predetermined direction of the elastic portion, an outer diameter of the distal end portion is substantially same along the predetermined direction, the protruding portion is provided to the distal end portion, and a side in the predetermined direction of the elastic portion is fixed to a side of the protruding portion opposite to the predetermined direction.

(8) The coupling device according to (7), wherein the valve portion is an annular body, and a second sealing portion is located radially inside the valve portion.

(9) The coupling device according to (8), wherein the second sealing portion is fixed to the valve portion with an adhesive.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A coupling device comprising:
a first portion including a first flow path and an attachment portion; and
a coupling portion; wherein
the coupling portion includes:
a first tubular portion including one end portion to be connected to a second tubular portion of a second portion including a second flow path; and
an arrangement portion provided to another end portion of the first tubular portion and to be attached to the attachment portion;
movement of the arrangement portion with respect to the first portion is suppressed in an axial direction of the first tubular portion;
the arrangement portion is movable with respect to the first portion in a radial direction of the first tubular portion; and
a maximum outer diameter of the arrangement portion is smaller than a maximum outer diameter of the first tubular portion.

2. The coupling device according to claim 1, wherein
the arrangement portion protrudes outward in the radial direction of the first tubular portion; and
a first sealing portion is located between the arrangement portion and the attachment portion.

3. The coupling device according to claim 1, wherein
the attachment portion includes:
a first plate attached to a first portion body including a first opening communicating with the first flow path; and
a second plate attached to the first portion body,
a first portion of the arrangement portion is provided between the first portion body and the first plate;
a second portion of the arrangement portion is provided between the first portion body and the second plate; and
the second portion is a portion different from the first portion.

4. The coupling device according to claim 3, wherein a diameter of the first opening is equal to or larger than a diameter of an opening of the arrangement portion.

5. The coupling device according to claim 1, wherein
the first tubular portion includes:
a coupling flow path extending along a predetermined direction; and
an inclined portion in which an outer diameter of the first tubular portion and a diameter of the coupling flow path decrease along the predetermined direction; and
the predetermined direction indicates a direction from the one end portion of the first tubular portion toward the another end portion of the first tubular portion.

6. The coupling device according to claim 5, wherein
the first tubular portion includes a recess recessed radially inward from an outer peripheral surface of the first tubular portion; and
the recess is provided to the arrangement portion in a direction opposite to the predetermined direction.

7. The coupling device according to claim 5, wherein
the first tubular portion further includes:
a distal end portion provided to a side opposite to the predetermined direction with respect to the inclined portion; and
a protruding portion protruding radially inward from an inner peripheral surface of the first tubular portion;
the coupling portion further includes:
an elastic portion; and
a valve portion located on a side opposite to the predetermined direction of the elastic portion;
an outer diameter of the distal end portion is substantially the same along the predetermined direction;
the protruding portion is provided to an inner peripheral surface of the distal end portion; and
a side in the predetermined direction of the elastic portion is fixed to a side of the protruding portion opposite to the predetermined direction.

8. The coupling device according to claim 7, wherein
the valve portion is an annular body; and
a second sealing portion is located radially inside the valve portion.

9. The coupling device according to claim 8, wherein the second sealing portion is fixed to the valve portion with an adhesive.
